(19) United States
(12) Patent Application Publication
(10) Pub. No.: US 2008/0007647 A1
(43) Pub. Date: Jan. 10, 2008

(54) Electronic appliance and power supply identification method

(75) Inventor: Isao Masuda, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/805,415

(22) Filed: May 23, 2007

(30) Foreign Application Priority Data
May 26, 2006 (JP) P2006-147061

(51) Int. Cl. H04N 5/225

(52) U.S. Cl. 348/372

(57) ABSTRACT

An electronic appliance that may use a secondary battery or an AC adapter as an external power supply is disclosed. The electronic appliance may include a power supply terminal, a communication terminal, an authentication processing section, a voltage comparing section, and a power supply determining section.

### CROSS-REFERENCE TO RELATED APPLICATIONS

This application claims priority from Japanese Patent Application No. JP 2006-147061 filed in the Japanese Patent Office on May 26, 2006, the entire content of which is incorporated herein by reference.

### BACKGROUND OF THE INVENTION

1. Field of the Invention

The invention relates to an electronic appliance that can use a secondary battery or an AC adapter as an external power supply and a power supply identification method in the electronic appliance and, in particular, to an electronic appliance including a common power supply terminal for a secondary battery and an AC adapter and a power supply identification method in the electronic appliance.

2. Description of the Related Art

In recent years, the number of mobile electronic appliances such as a digital still camera has rapidly increased, and the performance of the secondary battery to be attached to the electronic appliance has been increasingly valued. Such an electronic appliance may often use a special secondary battery for each product or product set. This is because a packet of each secondary battery accommodates a protective circuit and/or control circuit for danger prevention against the occurrence of an overcurrent situation or shortening, and each product has different circuit specifications. Notably, a package internally accommodating a secondary battery body and a protective circuit is called battery pack.

However, in recent years, imitation battery packs, which are manufactured in low costs by a third party unauthorized by a seller of each product, have been significantly distributed. In particular, some imitation battery packs may not internally contain a protective circuit for danger prevention, and accidents such as ignition and/or explosion of a battery thereof have been reported, which may be due to the fact.

For this reason, a battery pack in the past may internally contain a function of communicating with a microcomputer and an external appliance (that is, electronic appliance to receive the power supply) (refer to Japanese Patent No. 3575646 (paragraphs [0010] to [0018] and FIG. 2) (Patent Document 1), for example), and communicate with an electronic appliance by using the communication function when attached to the electronic appliance and perform authentication processing with the electronic appliance for precluding imitation batteries. In other words, a genuine battery pack for the electronic appliance is only usable by allowing a battery pack to supply power only when the battery pack is authenticated by the electronic appliance, which assures the security.

FIG. 7 is a diagram showing a construction example of an electronic appliance in the past that operates by receiving the power supply from a battery pack. Here, an imaging apparatus (such as a digital still camera) is illustrated as an example of the electronic appliance for explanation.

An imaging apparatus 100 shown in FIG. 7 includes an attachment section 101 for attaching a battery pack 200. The battery pack 200 has positive and negative power supply terminals 201 and 202 and a communication terminal 203 communicating with the imaging apparatus 100. When the battery pack 200 is attached to the attachment section 101, power is supplied from the power supply terminal 201 and 202 of the battery pack 200 to the imaging apparatus 100, and authentication processing is performed between the battery pack 200 and the imaging apparatus 100 through the communication terminal 203. Only if the imaging apparatus 100 determines that the battery pack 200 is genuine, the power supply is continued from the battery pack 200, making the imaging apparatus 100 usable.

Furthermore, many electronic appliances, which can be driven by a secondary battery, can be also driven by a commercial AC power supply instead of a second battery only and may often receive the commercial AC power supply through an external AC adapter in particular. The imaging apparatus 100 shown in FIG. 7 includes an AC power supply terminal 102 to which a terminal 301 of an AC adapter 300 is connected, in addition to the attachment section 101 for the battery pack 200, and the imaging apparatus 100 can operate by voltage supplied from the AC power supply terminal 102.

However, like the example in FIG. 7, there is a problem that the size of an exterior cabinet of the electronic appliance to which both secondary battery and AC adapter can connect may not be reduced since they may need respective connecting terminals and attachment spaces. Accordingly, the secondary battery (battery pack) and the AC adapter (or the terminal section) may share a common exterior cabinet and/or power supply terminal position such that the AC adapter (or the terminal section) can be attached at the position for attaching the battery pack. One electronic appliance can automatically determine which is connected thereto, the secondary battery or the AC adapter, based on the value of supplied voltage (refer to JP-A-9-298841 (paragraphs [0031] to [0038] and FIG. 9) (Patent Document 2), for example).

### SUMMARY OF THE INVENTION

By the way, when a battery pack and an AC adapter (or the terminal section) can be attached at a common position and when a common power supply terminal is shared as described above, the AC adapter may be necessary to have the same communication/authentication function as the communication/authentication function of the battery pack if any with the connected electronic appliance. However, the costs for manufacturing the AC adapter having such a communication/authentication function are disadvantageously increased. On the other hand, if the AC adapter does not have the communication/authentication function, the AC adapter may not share a common terminal with the battery pack, which may increase the costs for manufacturing the electronic appliance side due to the increased number of terminals, for example.

Accordingly, it may be desirable to propose an electronic appliance that can assure the security during power supply from a battery pack and may be usable by connecting an inexpensive AC adapter to a terminal, which is common to the battery pack and a power supply identification method in the electronic appliance.

According to an embodiment of the present invention, there is provided an electronic appliance that may use a secondary battery or an AC adapter as an external power supply, the electronic appliance may include a power supply terminal commonly provided for both of a battery pack accommodating the secondary battery and the AC adapter, a communication terminal communicating with a control section accommodated in the battery pack when the battery pack is connected to the power supply terminal, an authentication processing section communicating with the control section within the battery pack through the communication terminal and supplying the voltage applied to the power supply terminal to the inside of the electronic appliance only if it is determined that the other communication party is the battery pack, which is genuine, a voltage comparing section comparing the voltage applied to the power supply terminal and a predetermined reference voltage, and a power supply determining section causing the authentication processing section to perform communication/authentication processing with the control section within the battery pack if the voltage applied to the power supply terminal is lower than the reference voltage based on the comparison result by the voltage comparing section and supplying the voltage applied to the power supply terminal to the inside of the electronic appliance without operating the authentication processing section if the voltage applied to the power supply terminal is equal to or higher than the reference voltage.

The electronic appliance may receive power supply by connecting one of a battery pack accommodating a secondary battery and an AC adapter to a common power supply terminal. When the battery pack is connected to the power supply terminal, the electronic appliance may communicate with a control section accommodated in the battery pack through a communication terminal. In the electronic appliance, a voltage comparing section may compare a voltage applied to the power supply terminal with a predetermined reference voltage. The reference voltage may be a voltage lower than a prescribed voltage supplied from the AC adapter and near the prescribed voltage, for example. A power supply determining section may perform an operation of identifying a power supply based on the comparison result by the voltage comparing section.

If the voltage applied to the power supply terminal is lower than the reference voltage, the power supply determining section may cause the authentication processing section to perform communication/authentication processing with the control section within the battery pack. The authentication processing section may communicate with the control section within the battery pack through the communication terminal and allow the voltage applied to the power supply terminal to be supplied to the inside of the electronic appliance only if it is determined that the other communication party is a genuine battery pack. If the voltage applied to the power supply terminal is equal to or higher than the reference voltage, the power supply determining section may determine that an AC adapter is connected thereto and allow the voltage applied to the power supply terminal to be supplied to the inside of the electronic appliance without operating the authentication processing section.

According to embodiments of the invention, since a common power supply terminal may be provided to both of a battery pack accommodating a secondary battery and an AC adapter, the size of the electronic appliance body can be reduced. Furthermore, based on the comparison result by the voltage comparing section, either battery pack or AC adapter may be determined as the one connecting to the electronic appliance. If a battery pack is connected to the electronic appliance, and only if the communication/authentication processing determines that the battery pack is genuine, the voltage applied to the power supply terminal may be allowed to be supplied to the inside of the electronic appliance. Thus, a genuine battery pack is only usable, which improves the security. If an AC adapter is connected to the electronic appliance, the voltage from the AC adapter may be allowed to be supplied to the inside of the electronic appliance without performing communication/authentication processing. Thus, an inexpensive AC adapter without the communication/authentication function is usable. Therefore, an electronic appliance can be provided which may be operable by the power supply from an inexpensive AC adapter and highly marketable without loss of the security during the power supply from a battery pack.

### BRIEF DESCRIPTION OF THE DRAWINGS

FIG. 1 is a diagram showing appearances of an imaging apparatus according to an embodiment of the present invention and a battery pack and AC adapter to be attached therein;

FIG. 2 is a block diagram showing internal constructions of the imaging apparatus and battery pack;

FIG. 3 is a block diagram showing internal constructions of the AC adapter and a connecting unit thereof;

FIG. 4 is a graph showing the transitions in voltage of a battery cell;

FIG. 5 is a flowchart illustrating steps of power-supply identifying processing in the imaging apparatus;

FIG. 6 is a diagram showing a screen display example of display information describing that a battery pack is not usable; and

FIG. 7 is a diagram showing a construction example of an electronic appliance in the past that operates by receiving power supply from a battery pack.

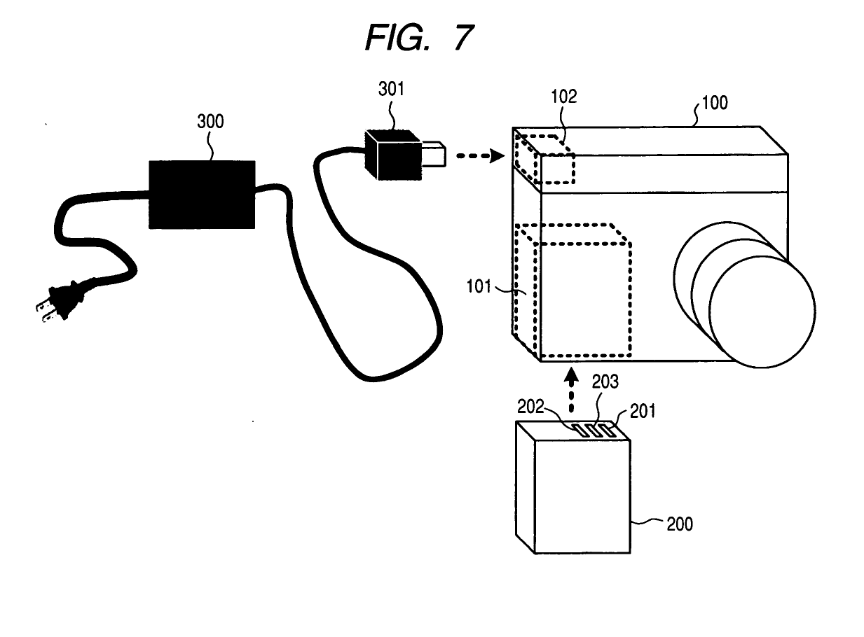

### DETAILED DESCRIPTION

With reference to drawings and based on an example that an embodiment of the invention is applied to an imaging apparatus implemented as a digital still camera or a digital video camera, the embodiment will be described in detail below.

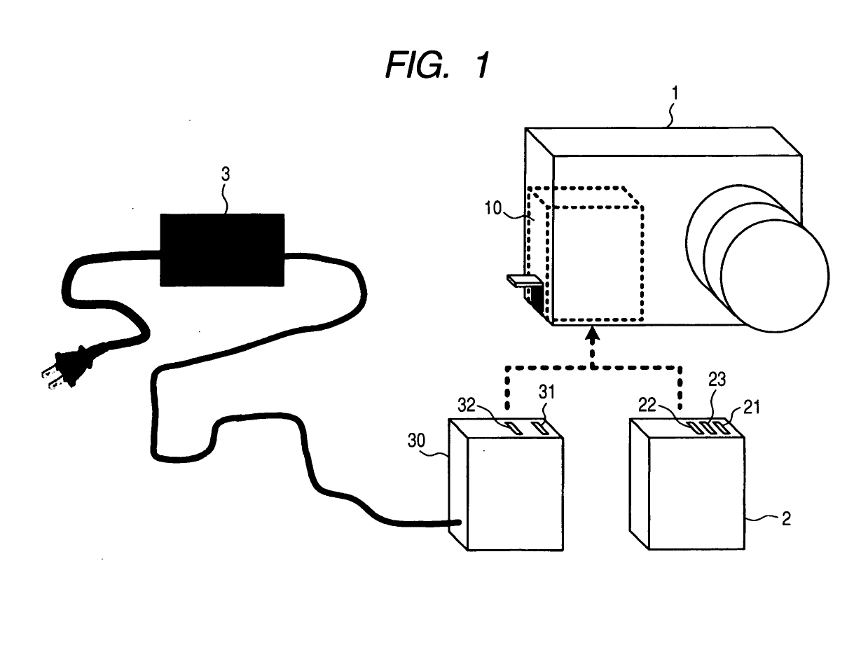

FIG. 1 is a diagram showing appearances of an imaging apparatus according to this embodiment of the present invention and a battery pack and AC adapter to be installed therein.

An imaging apparatus 1 shown in FIG. 1 can be driven by receiving power supply from a secondary battery accommodated in a battery pack 2 or can be driven by receiving power supply from an AC adapter 3 instead of a secondary battery. The external surface of the battery pack 2 has a positive terminal 21 and negative terminal 22 for feeding power to the imaging apparatus 1 and a communication terminal 23 for communication with the imaging apparatus 1. On the other hand, the imaging apparatus 1 includes an attachment section 10 for attaching the battery pack 2. When the battery pack 2 is attached to the attachment section 10, power is supplied to the imaging apparatus 1 through the positive terminal 21 and negative terminal 22, and the imaging apparatus 1 and the battery pack 2 can communicate with each other through the communication terminal 23. The imaging apparatus 1 has a function of authenticating whether the battery pack 2 is genuine or not by communicating with the battery pack 2, as described later.

A connecting unit 30 for connecting to the imaging apparatus 1 is connected to an AC adapter 3. The exterior of the connecting unit 30 has an identical form and size to those of the battery pack 2, and the connecting unit 30 can be attached to the attachment section 10 of the imaging apparatus 1, like the battery pack 2. The connecting unit 30 has a positive terminal 31 and negative terminal 32 for power feeding from the AC adapter 3 at positions corresponding to the positive terminal 21 and negative terminal 22, respectively, on the battery pack 2. Thus, when one of the battery pack 2 and connecting unit 30 is attached to the attachment section 10, the imaging apparatus 1 can receive power supply through the terminal, which is common to both.

Having described that the battery pack 2 and the connecting unit 30 of the AC adapter 3 have an identical form according to this embodiment, the connecting unit 30 may only required to be attachable to the attachment section 10 of the imaging apparatus 1 and to allow the positive terminal 31 and negative terminal 32 to connect to terminals, which are internally provided in the attachment section 10 and also shared by the battery pack 2.

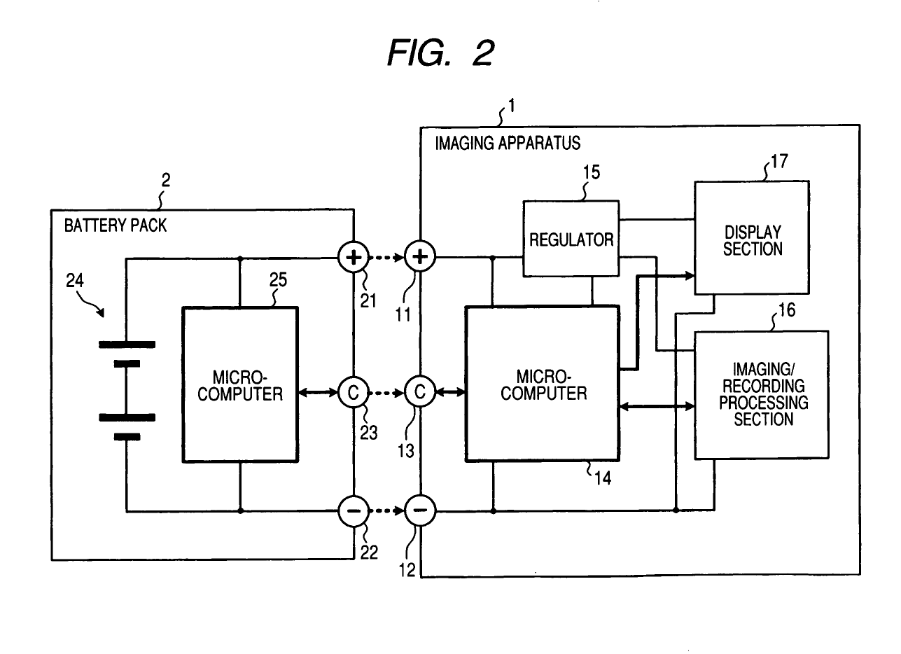

FIG. 2 is a block diagram showing internal constructions of the imaging apparatus and battery pack.

As shown in FIG. 2, the imaging apparatus 1 includes a positive terminal 11 and negative terminal 12 for receiving power supply, a communication terminal 13, a microcomputer 14, a regulator 15, an imaging/recording processing section 16 and a display section 17. The battery pack 2 includes a battery cell 24 and microcomputer 25.

When the battery pack 2 is attached to the imaging apparatus 1, the positive terminal 21, negative terminal 22 and communication terminal 23 of the battery pack 2 are connected to the positive terminal 11, negative terminal 12 and communication terminal 13 of the imaging apparatus 1, respectively. Power is supplied from the battery pack 2 to the imaging apparatus 1 through the positive terminal 11 and negative terminal 12.

The microcomputer 14 of the imaging apparatus 1 is a control section centrally controlling operations of the imaging apparatus 1. The microcomputer 14 has a function of communicating with the microcomputer 25 within the battery pack 2 through the communication terminal 13 and performing authentication processing on the battery pack 2. Then, if the microcomputer 14 determines that the communicating battery pack 2 is not genuine, the microcomputer 14 controls the imaging apparatus 1 to power off so that the invalid battery pack may not be usable. The microcomputer 14 further has a function of detecting a potential difference (that is, power supply voltage) between the positive terminal 11 and the negative terminal 12 and determining which has been connected thereto, the battery pack 2 or the connecting unit 30 of the AC adapter 3.

The regulator 15 stabilizes the power supply voltage applied to the positive terminal 11 and negative terminal 12 to a predetermined voltage and supplies the voltage to the inside of the apparatus. The imaging/recording processing section 16 is a block performing processing such as imaging an image, recording image data obtained by imaging to a recording medium, creating display data of an image being imaged or a recorded image and so on. The display section 17 has an LCD (Liquid Crystal Display), for example, and receives display data created by the imaging/recording processing section 16 and microcomputer 14 and displays the image.

On the other hand, the battery pack 2 supplies voltage generated by the battery cell 24 to the imaging apparatus 1 through the positive terminal 21 and negative terminal 22. The microcomputer 25 communicates with the microcomputer 14 of the imaging apparatus 1 through the communication terminal 23 and processes and responds authentication information transmitted from the microcomputer 14.

The microcomputer 25 includes a protective function for keeping the security during charging/discharging to/from the battery cell 24. For example, when the value of the voltage or current of the battery cell 24 is excessive, the microcomputer 25 controls to shut down the charged current or discharged current. Thus, the abnormal event such as ignition, explosion and deformation of the battery pack 2 due to an excessive increase in temperature can be prevented.

The microcomputer 14 of the imaging apparatus 1 may have a function of displaying a remaining amount of the battery cell 24 of the battery pack 2. In this case, for example, the microcomputer 25 of the battery pack 2 adds up charged/discharged currents in the battery cell 24 in a predetermined cycle. Then, the microcomputer 14 of the imaging apparatus 1 obtains the integral value of the charged/discharged current from the microcomputer 25 of the battery pack 2, calculates the remaining time when the battery cell 24 is usable based on the integral value and amount of power consumption on the imaging apparatus 1 side and causes the display 17 to display the result.

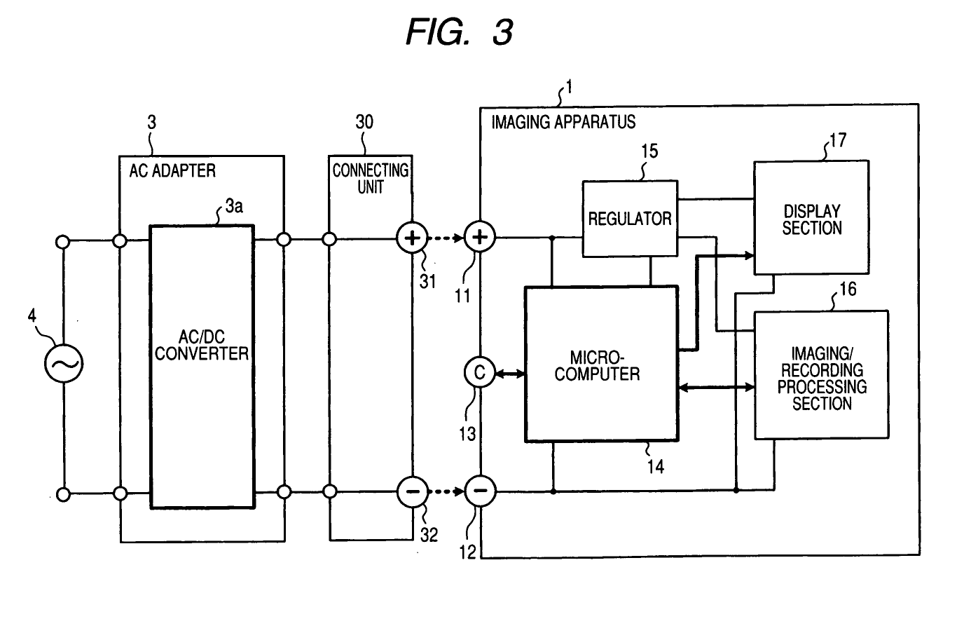

FIG. 3 is a block diagram showing internal constructions of the AC adapter and connecting unit.

As shown in FIG. 3, the AC adapter 3 includes an AC/DC converter 3a that converts AC voltage supplied from the commercial AC power supply 4 to direct current voltage. The converted DC voltage is supplied to the imaging apparatus 1 through the positive terminal 31 and negative terminal 32 of the connecting unit 30. The connecting unit 30 may have a part of the circuit that the AC adapter 3 has. Alternatively, the AC adapter 3 itself may be integrated to the connecting unit 30.

In the imaging apparatus 1, by allowing the battery pack 2 and connecting unit 30 of the AC adapter 3 to be attached to the common attachment section 10 and having the construction in which the voltage supplied from the battery pack 2 or AC adapter 3 is received through a common feeding terminals (that is, the positive terminal 11 and negative terminal 12), the amount of spaces for circuits and/or mechanisms for the battery pack 2 and AC adapter 3, such as the feeding terminals and attachment sections, can be reduced. This reduces the size of the imaging apparatus 1, and the internal circuit is simplified, which may reduce the manufacturing costs. When the battery pack 2 is attached to the imaging apparatus 1, authentication processing thereon is performed by communicating with the battery pack 2, and whether the attached battery pack 2 is a genuine one that has a protective function or not can be determined. This can preclude imitation battery packs the security of which has not been checked by a manufacturer thereof and thus can improve the security for battery pack use.

On the other hand, as shown in FIG. 3, the AC adapter 3 and the connecting unit 30 therefor do not have a communication/authentication function and a microcomputer for implementing the function, both of which are included in the battery pack 2. This construction can reduce the manufacturing costs of the AC adapter 3 and connecting unit 30.

However, since this construction does not allow the imaging apparatus 1 side to communicate with the connecting unit 30 when the connecting unit 30 is attached to the imaging apparatus 1, the connecting unit 30 may be recognized as an invalid battery pack, which results in the rejection of feeding. Then, according to this embodiment, the imaging apparatus 1 determines which is attached thereto, battery pack 2 or connecting unit 30, based on the voltage applied between feeding terminals and performs the communication/authentication processing thereon only if it is determined that the battery pack 2 has been attached. Thus, the inexpensive AC adapter 3 and connecting unit 30 without the communication/authentication function is usable.

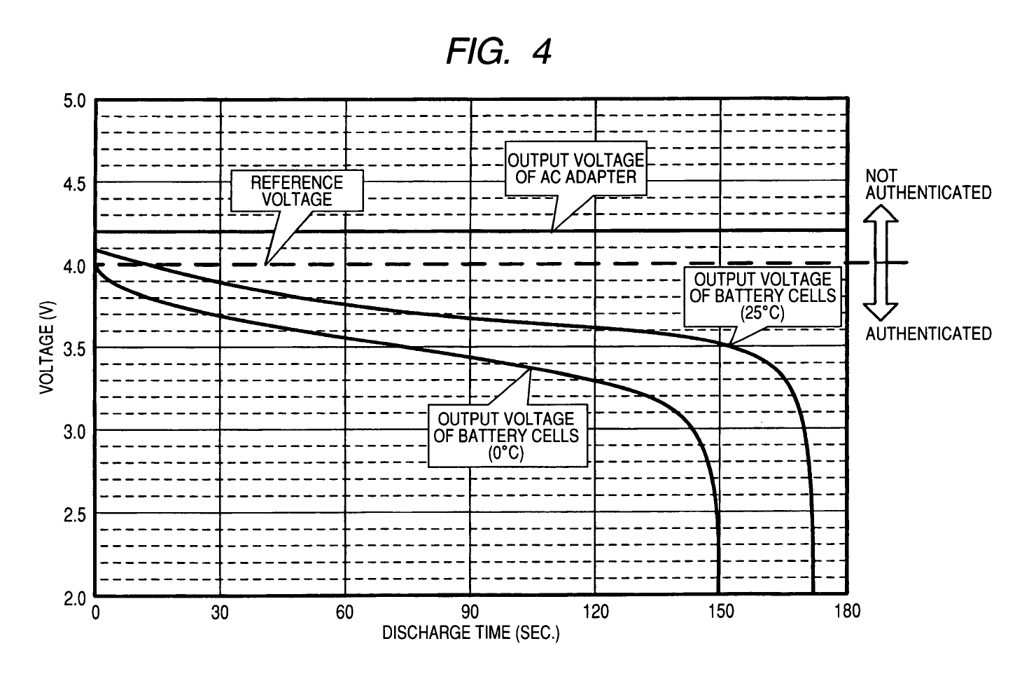

FIG. 4 is a graph showing a transition in voltage from a battery cell. FIG. 4 shows an output voltage of the battery cell 24 and also shows an output voltage from the AC adapter 3 and a reference voltage for the power supply determination.

The AC adapter 3 outputs a constant voltage at all times. For example, the prescribed output voltage of the AC adapter 3 is 4.2 V here. On the other hand, while the output voltage prescribed in the battery cell 24 is also basically the same as that of the AC adapter 3, the battery cell 24 has a characteristic that the output voltage gradually decreases from the fully charged state with the passage of time. FIG. 4 shows the transition in output voltage at temperatures 25° C. and 0° C. in a case with a lithium ion secondary battery, for example.

As shown in FIG. 4, the battery cell 24 outputs a substantially equal voltage to the output voltage of the AC adapter 3 immediately after the start of discharging, but the output voltage decreases shortly after the start of discharging. The discharging characteristic is not limited to a lithium ion secondary battery but is mostly common to all of secondary batteries. Then, the determination can be performed on which is connected between the connecting unit 30 of the AC adapter 3 or battery cell 24 by defining a reference value, which is a slightly lower value than that of the output voltage of the AC adapter 3. According to this embodiment, the reference value is 4.0 V, for example.

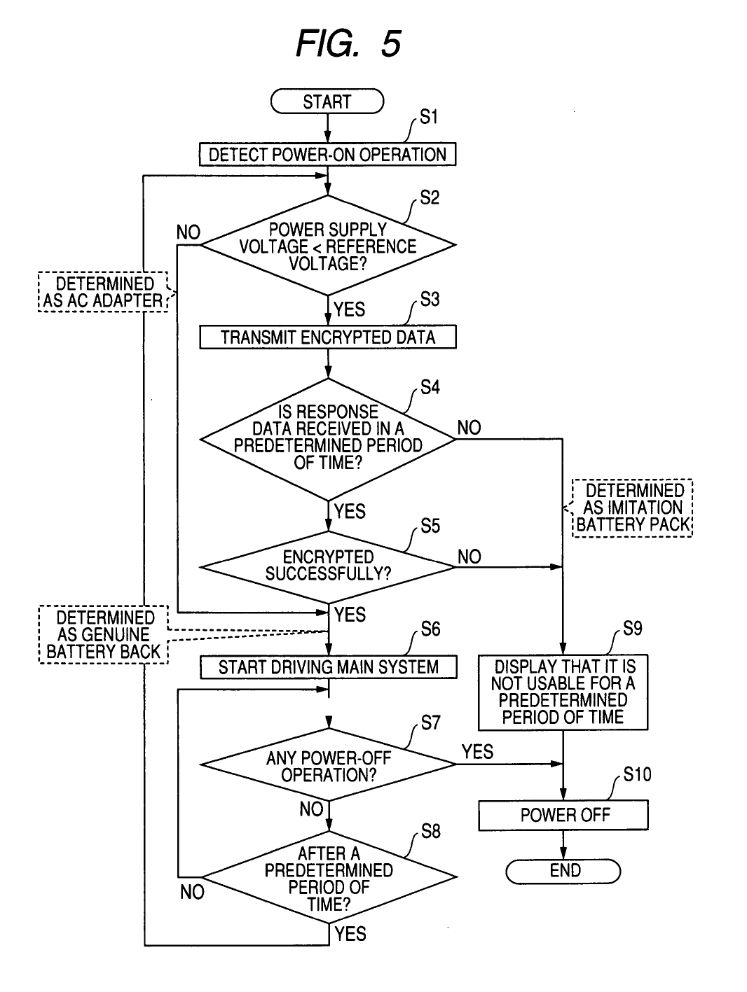

FIG. 5 is a flowchart showing steps of the power supply determination processing in the imaging apparatus.

First, in the imaging apparatus 1, the microcomputer 14 detects that a user performs an operational input for powering on (step S1). Then, the microcomputer 14 obtains the power supply voltage between the positive terminal 11 and negative terminal 12 and compares the power supply voltage and the reference voltage (step S2).

If the power supply voltage is equal to or higher than the reference voltage, the microcomputer 14 determines that the connecting unit 30 of the AC adapter 3 has been attached thereto and starts driving the main system (step S6). For example, the output voltage from the regulator 15 is supplied to the imaging/recording processing section 16 and display section 17 to shift to a system state that allows an imaging operation and/or image recording operation.

On the other hand, if the power supply voltage is lower than the reference voltage, the microcomputer 14 starts the authentication processing and first transmits encrypted data through the communication terminal 13 (step S3). Then, the microcomputer 14 waits for the reception of the response data to the encrypted data for a predetermined period of time (step S4). Here, if the genuine (valid) battery pack 2 is attached thereto, the microcomputer 25 in the battery pack 2 receives the encrypted data transmitted from the imaging apparatus 1 through the communication terminal 23 and decrypts the encrypted data by using key information the microcomputer 25 already holds. If the decryption succeeds, the response data is created by using information used in the process of decryption, for example, and is transmitted to the imaging apparatus 1 through the communication terminal 23.

If the microcomputer 14 of the imaging apparatus 1 receives the response data within the predetermined period of time from the transmission of the encrypted data (step S4), the response data is decrypted and is determined whether it is valid data or not (step S5). If it is determined as valid response data, the microcomputer 14 determines that the genuine battery pack 2 has been attached thereto and starts driving the main system (step S6).

If the response data is not determined as valid data (step S5) and if the response data is not received within the predetermined period of time from the transmission of the encrypted data (step S4), the microcomputer 14 determines that an imitation battery pack has been attached thereto. Then, the display section 17 is caused to display, for a predetermined period of time, the display information describing that the battery pack is not usable (step S9), and then the imaging apparatus 1 is powered off (step S10). The response data is not transmitted if the battery pack side may not decrypt the encrypted data or if the battery pack does not have a function of decrypting the encrypted data (that is, the authenticating function). Therefore, the microcomputer 14 can determine the attachment of an imitation battery pack by not receiving the response data within the predetermined period of time from the transmission of the encrypted data in step S4.

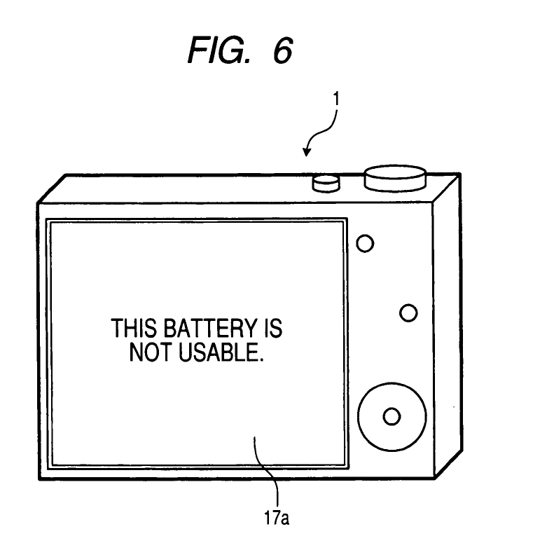

FIG. 6 is a diagram showing a screen display example of the display information describing that the battery pack is not usable in step S9 above.

In FIG. 6, an LCD 17a on the back face of the imaging apparatus 1 for checking the angle of view is used as the display section 17, and the LCD 17a displays text information describing that the attached battery pack is not usable. If it is determined that any imitation battery pack is attached to the imaging apparatus 1, the imaging apparatus 1 displays the information for a predetermined period of time (such as five seconds) and then is powered off so as not to be usable.

Referring back to FIG. 5, after the driving of the main system is started (step S6), the microcomputer 14 determines whether any operation input for powering off has been performed or not (step S7). If it is determined that the operation input has been performed, the imaging apparatus 1 is powered off (step S10). If no operation input has been performed, the microcomputer 14 determines whether a predetermined period of time has been passed or not (step S8) and monitors an operation input for powering off until the expiration of the predetermined period of time (step S7). Upon expiration of the predetermined period of time from the start of the driving of the main system (step S8), the microcomputer 14 obtains the power supply voltage between the positive terminal 11 and the negative terminal 12 again and performs processing in and subsequent to step S2.

The processing above determines that power is supplied from a battery pack if the power supply voltage is lower than a reference voltage and performs the authentication processing on the battery pack. Thus, a dangerous imitation battery pack without a protective function is not allowed to use and can therefore securely improve the security in using a battery pack. In addition, if the power supply voltage is equal to or higher than the reference voltage, it can be determined that power is supplied from the AC adapter 3. Thus, driving the main system can be started without the authentication processing to make the imaging apparatus 1 normally usable. Therefore, the inexpensive AC adapter 3 and/or connecting unit 30 without the communication/authentication function and microcomputer can be used without problems. As a result, the security during use can be improved, and the imaging apparatus 1 in a small size can be achieved in a low price including accessories thereof (such as the AC adapter 3).

Furthermore, since the output voltage of a battery pack immediately after fully charged can be equal to or higher than the reference voltage as shown in FIG. 4, the authentication processing is not performed under this condition, which makes an imitation battery pack usable. However, after driving the main system is started, the processing above compares between the power supply voltage and the reference voltage every predetermined period of time to determine the power supply. Therefore, even imitation battery pack, which is made usable once, is not allowed to use with the decrease in output voltage after that. Since, as shown in FIG. 4, the output voltage of a secondary battery decreases shortly after the discharging starts, the time when an imitation battery pack is usable is of the order, at most, of several minutes. As a result, the security during use of a battery pack can be securely improved.

In the processing in FIG. 5, if it is determined that the power supply is a genuine battery pack, the subsequent processing of comparing between the power supply voltage and the reference voltage (step S2) can be eliminated. In other words, by repeating the processing comparing between the power supply voltage and a reference voltage every predetermined period of time during a period when the power supply is determined as an AC adapter at least, the continuous use of an imitation battery pack can be made unusable.

Having described that the present invention is applied to an imaging apparatus according to the embodiment above, the invention is also applicable to any electronic appliances, which can be driven by using both secondary battery and AC adapter.

It should be understood by those skilled in the art that various modifications, combinations, sub-combinations and alterations may occur depending on design requirements and other factors insofar as they are within the scope of the appended claims or the equivalents thereof.

1. An electronic appliance that can use a secondary battery or an AC adapter as an external power supply, the electronic appliance comprising:
a power supply terminal commonly provided for both of a battery pack accommodating the secondary battery and the AC adapter;
a communication terminal communicating with a control section accommodated in the battery pack when the battery pack is connected to the power supply terminal;
an authentication processing section communicating with the control section within the battery pack through the communication terminal and supplying the voltage applied to the power supply terminal to the inside of the electronic appliance only if it is determined that the other communication party is the battery pack, which is genuine;
a voltage comparing section comparing the voltage applied to the power supply terminal and a predetermined reference voltage; and
a power supply determining section causing the authentication processing section to perform communication/authentication processing with the control section within the battery pack if the voltage applied to the power supply terminal is lower than the reference voltage based on the comparison result by the voltage comparing section and supplying the voltage applied to the power supply terminal to the inside of the electronic appliance without operating the authentication processing section if the voltage applied to the power supply terminal is equal to or higher than the reference voltage.

2. The electronic appliance according to claim 1, wherein the reference voltage is a voltage lower than and close to a prescribed voltage to be supplied from the AC adapter.

3. The electronic appliance according to claim 1, wherein the power supply determining section refers to the comparison result by the voltage comparing section every predetermined period of time from the time when the electronic appliance is powered on as a starting point and repeats a power supply determining operation based on the comparison result until the voltage applied to the power supply terminal is lower than the reference voltage.

4. The electronic appliance according to claim 1, wherein the electronic appliance is powered off if the authentication processing section determines that the other communication party is not the genuine battery pack.

5. The electronic appliance according to claim 1, further comprising an image display section displaying various images,
wherein image information describing the fact that the battery pack is not usable is displayed on the image display section before the electronic appliance is powered off if the authentication processing section determines that the other communication party is not the genuine battery pack.

6. The electronic appliance according to claim 1, further comprising a power supply attachment section to which the battery pack and the power supply terminal of the AC adapter can be commonly attached.

7. A power supply identification method in an electronic appliance that can use a secondary battery or an AC adapter as an external power supply, the method comprising:
comparing the voltage applied through a power supply terminal commonly provided to both of a battery pack accommodating the secondary battery and the AC adapter and a predetermined reference voltage by a voltage comparing section; and
controlling, by a power supply determining section, the authentication processing section to communicate with a control section within the battery pack through a communication terminal if the voltage applied to the power supply terminal is lower than the reference voltage based on the comparison result by the voltage comparing section and to supply the voltage applied to the power supply terminal to the inside of the electronic appliance only if it is determined that the other communication party is the battery pack, which is genuine, and supplying the voltage applied to the power supply terminal to the inside of the electronic appliance without operating the authentication processing section if the voltage applied to the power supply terminal is equal to or higher than the reference voltage.
